(19) United States
(12) Patent Application Publication
(10) Pub. No.: US 2011/0058254 A1
(43) Pub. Date: Mar. 10, 2011

(54) INTEGRAL PHOTOGRAPHY PLASTIC SHEET BY SPECIAL PRINT

(76) Inventor: Soo-In Choi, Gyeonggi-do (KR)

(21) Appl. No.: 12/665,507

(22) PCT Filed: Sep. 18, 2007
(86) PCT No.: PCT/KR2007/004522

§ 371 Date: Nov. 23, 2010

(30) Foreign Application Priority Data
Jun. 27, 2007 (KR) 10-2007-0063470

(51) Int. Cl. G02B 27/22

(52) U.S. Cl. 359/463

(57) ABSTRACT

The present invention relates to a stereoscopic plastic sheet which includes a convex lens layer having hemispherical convex lenses formed on a top surface thereof in a row and column arrangement, so that a clear stereoscopic picture can be seen regardless of directions when viewed from the front of the sheet, and in which the conventional IP printing method can be improved and modified to a printing method by computer graphics, the advantages of special effects of IP and printing suitable for mass production can be applied, a moire phenomenon and a glitter phenomenon, which may occur in the printing method, can be minimized, clear stereoscopic or special images can be seen, and a fabrication process can be reduced.

### TECHNICAL FIELD

The present invention relates to a stereoscopic method employing an integral photography (IP). The stereoscopic method is a method proposed by Gabriel. M. Lippmann (France) in 1908, but was difficult to become practical at that time because it required a high-level precision machining technology and image decomposition photography technology. However, in recent years, the stereoscopic method has become practical with the development of various technology development and various printing techniques by digital outputs.

### BACKGROUND ART

This stereoscopic representation method further facilitates the development of computer graphics. Stereoscopic printed matter becomes able to be produced even by a household inkjet printing method.

However, this inkjet printing method is generally a method that is not suitable for mass production because it has a very slow printing speed.

For the purpose of mass production, traditional printing methods, such as Offset, Gravure and Flexography, are used. The traditional printing methods are all ink transfer methods and are performed by a halftone screen-printing method.

However, this halftone screen-printing method is problematic in the stereoscopic printing of the IP method. This is because a moire phenomenon occurs in stereoscopic picture products due to a pattern angle of the halftone screen.

This is because the screen arrangement angles of the 4-color (C, M, Y, K) halftones, which form major figures or colors, contradict the arrangement of convex lenses of the stereoscopic plastic sheet, and the halftones of the 4 colors are enlarged by a piece of the convex lenses are seen as a disturbed pattern, that is, moire. In this case, printing of a stereoscopic pattern comprising mainly a spot color 1 is seen normally, but figures by printing of 4-color halftone screen have a degraded quality due to the moire phenomenon, resulting in a reduced feeling of stereography or special effects.

Thus, in the conventional method, in order to remove the phenomenon, a stereoscopic printing surface on which a 3D is represented and a graphic printing surface on which major figure or colors are formed are printed with them being separated from each other. However, a method of removing the moire phenomenon is used in which the stereoscopic printing surface of spot color printing is formed in the focal length of the convex lens and the graphic printing surface on which major figures or colors are represented is disposed in a non-focal length close to the convex lens surface, so that the magnifier effect of the convex lenses is removed. However, this method has low workability due to double tasks such as separation, printing, and then coupling again.

In another method of removing the moire phenomenon, the stereoscopic printing surface that has experienced mainly spot colors and the graphic printing surface on which major figures or colors are represented are printed together on a lower surface of a stereoscopic plastic sheet. However, transparent ink resin is printed on a top surface of the convex lens right on the printing surface on which major figures are printed, removing the moire phenomenon. This method employs a method of deviating the major figure printing surface from the moire phenomenon (that is, an expansion phenomenon of halftones) by employing a phenomenon in which the transparent ink is filled between valleys of the convex lenses in order to reduce the role of the convex lens. However, this method also generates inconvenience in workability due to an additional printing task.

### DISCLOSURE OF INVENTION

### Technical Problem

Accordingly, the present invention has been made in an effort to solve the above-mentioned problems occurring in the prior art, and an object of the present invention is to provide a stereoscopic plastic sheet which includes a convex lens layer having hemispherical convex lenses formed on a top surface thereof in a row and column arrangement, so that a clear stereoscopic picture can be seen regardless of directions when viewed from the front of the sheet, and in which the conventional IP printing method can be improved and modified to a printing method by computer graphics, the advantages of special effects of IP and printing suitable for mass production can be applied, a moire phenomenon and a glitter phenomenon, which may occur in the printing method, can be minimized, clear stereoscopic or special images can be seen, and a fabrication process can be reduced.

### Technical Solution

To achieve the above object, the present invention provides an integral photography stereoscopic plastic sheet, including a convex lens layer 10 formed of transparent synthetic resin and having hemispherical convex lenses 11 formed on a top surface thereof in a row and column arrangement; a transparent sheet 20 formed beneath the convex lens layer 10 and formed of a synthetic resin plate having a thickness corresponding to a quasi-focal length of the convex lens 11; a graphic printing surface 41 printed on a bottom surface of the transparent sheet 20 to form a microdot structure 80 by a FM screen method and configured to enable a real picture to be seen through the graphic printing surface; and stereoscopic printing surfaces 42, 42-1 printed in the same quasi-focal length as that of the graphic printing surface 41 and configured to enable graphics, which have been calculated and image-processed by computer graphics, to be seen through a stereoscopic screen, wherein the convex lens layer 10 and the printing surfaces 41, 42, and 42-1 form visual arrangements corresponding to the transparent sheet 20 of a quasi-focal length distance, and is formed of one sheet.

### ADVANTAGEOUS EFFECTS

According to the present invention as described above, in the event that a stereoscopic sheet 1 is monitored through a convex lens layer 10, a clear stereoscopic picture in which figures of a graphic printing surface 41 comprised of products or subject figures stay in the air or are entered into a stereoscopic printing surface 42 comprised of numerous figures or drawing produced by special printing. Accordingly, there are advantages in that a stereoscopic sheet through which a feeling of a high-level stereography can be felt can be provided, and a clear stereoscopic picture can be seen although it is monitored from any direction regardless of a position or direction where the stereoscopic plastic sheet 1 is placed because the lens consists of hemispherical convex lens 11.

Further, there are advantages in that the conventional IP printing method can be improved and modified to a printing method by computer graphics, the advantages of special effects of IP and printing suitable for mass production can be employed, a moire phenomenon and a glitter phenomenon, which may occur in the printing method, can be minimized, clear stereoscopic or special images can be seen, and a fabrication process can be reduced, increasing competitiveness.

### BRIEF DESCRIPTION OF THE DRAWINGS

Further objects and advantages of the invention can be more fully understood from the following detailed description taken in conjunction with the accompanying drawings in which:

FIG. 1 is a dismantled perspective view illustrating an embodiment of the present invention;

FIG. 2 is a cross-sectional view illustrating an embodiment of the present invention;

FIG. 3 is a partially enlarged view illustrating a printing method of the present invention as an embodiment;

FIG. 4 is a cross-sectional view and a partial plan view illustrating an embodiment of the present invention;

FIG. 5 is a partially explanatory and enlarged view illustrating an embodiment of the present invention;

FIG. 6 is a partial view of a stereoscopic plastic sheet by a positive focal length-printing layer illustrating another embodiment of the present invention;

FIG. 7 is a partial view of a stereoscopic plastic sheet by a non-focal length-printing layer illustrating another embodiment of the present invention;

FIG. 8 is a view illustrating a general figure according to an embodiment of the present invention;

FIG. 9 is a view illustrating a graphic printing surface and a stereoscopic printing surface according to an embodiment of the present invention;

FIG. 10 is a view illustrating a stereoscopic printing surface and a special effect printing surface according to an embodiment of the present invention;

FIG. 11 is a view illustrating slope angles of spot colors or 4-color halftones that are printed in the present invention;

FIG. 12 is a plan view illustrating a state where convex lenses are arranged at a slope of 45° in a convex lens layer according to the present invention; and

FIG. 13 is a plan view illustrating a state where convex lenses are arranged at a slope of 60° in a convex lens layer according to the present invention.

### DESCRIPTION OF REFERENCE NUMERALS OF PRINCIPAL ELEMENTS IN THE DRAWINGS

1: stereoscopic plastic sheet by quasi-focal length-printing layer
2: stereoscopic plastic sheet by positive focal length-printing layer
3: stereoscopic plastic sheet by non-focal length-printing layer
10: convex lens layer
11: convex lens
14: focal forming angle
20: transparent sheet
30: non-focal length
40: quasi-focal length [shorter than positive focal length]
40-1: quasi-focal length [longer than positive focal length]
41: graphic printing surface
42: stereoscopic printing surface
42-1: special effects printing surface
43: quasi-focal length-printing layer
50: positive focal length
53: positive focal length-printing layer
60: microdot by FM screening method
61: microdot of quasi-focal length, which is seen through a piece of convex lens
62: microdot of positive focal length, which is seen through a piece of convex lens
63: microdot of non-focal length, which is seen through a piece of convex lens
70: halftone structure for printing by AM screening method
80: microdot structure for printing by FM screen method
90: image-separated picture (graphic pattern) from image to be represented as stereoscopic picture
91: region to be stereoscopically seen through convex lenses
92: image-combined picture that is stereoscopically gathered and projected through convex lenses

### BEST MODE FOR CARRYING OUT THE INVENTION

The present invention provides an integral photography stereoscopic plastic sheet, including a convex lens layer 10 formed of transparent synthetic resin and having hemispherical convex lenses 11 formed on a top surface thereof in a row and column arrangement; a transparent sheet 20 formed beneath the convex lens layer 10 and formed of a synthetic resin plate having a thickness corresponding to a quasi-focal length of the convex lens 11; a graphic printing surface 41 printed on a bottom surface of the transparent sheet 20 to form a microdot structure 80 by a FM screen method and configured to enable a real picture to be seen through the graphic printing surface; and stereoscopic printing surfaces 42, 42-1 printed in the same quasi-focal length as that of the graphic printing surface 41 and configured to enable graphics, which have been calculated and image-processed by computer graphics, to be seen through a stereoscopic screen, wherein the convex lens layer 10 and the printing surfaces 41, 42, and 42-1 form visual arrangements corresponding to the transparent sheet 20 of a quasi-focal length distance, and is formed of one sheet.

### MODE FOR THE INVENTION

The present invention will now be described in detail in connection with specific embodiments with reference to the accompanying drawings.

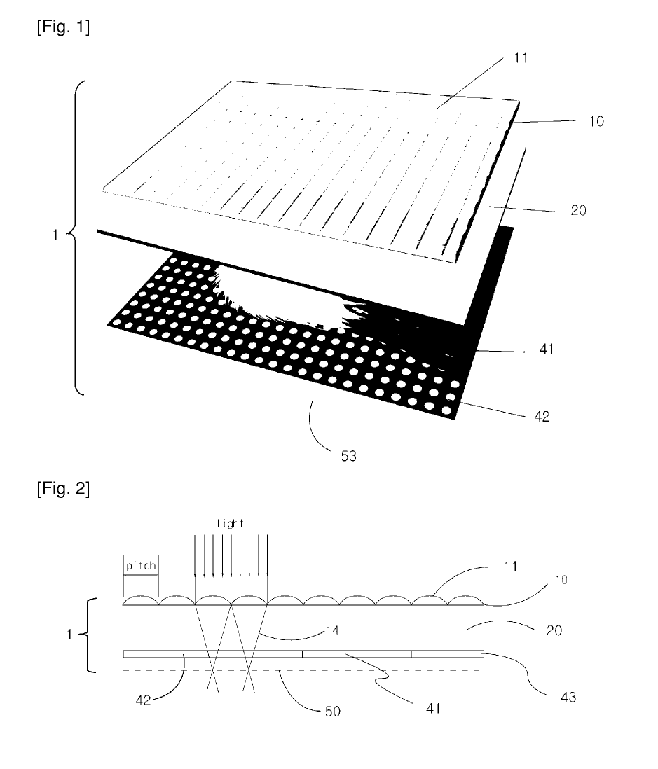

As shown in FIGS. 1 to 4, a convex lens layer 10 is formed at the top of a stereoscopic plastic sheet 1 according to the present invention.

The convex lens layer 10 is formed by molding a transparent synthetic resin. Hemispherical convex lenses 11 are radially spread on the resin in a longitudinal and traverse arrangement.

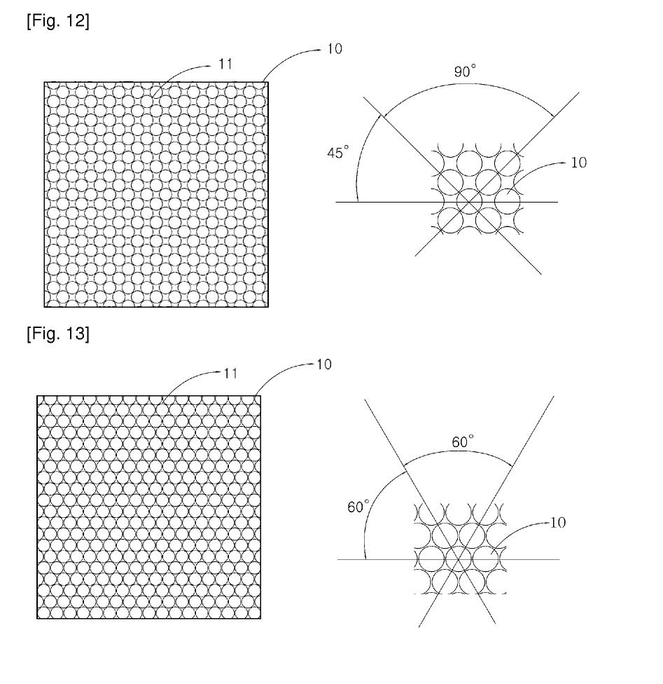

The convex lenses 11 that are arranged on the convex lens layer 10 in a row and column arrangement are arranged such that crossing angle of virtual lines to travel the center of the convex lenses 11 has 90° and the slope of the convex lenses 11 has 45° as shown in FIG. 12.

Alternatively, the crossing angle of the virtual lines can have 60° so that the slope of the convex lenses 11 has 60° as shown in FIG. 13. In the present invention, however, it is preferred that the slope of the convex lenses 11 has 45°.

A transparent sheet 20 made of transparent synthetic resin is disposed below the convex lens layer 10. The transparent sheet 20 has the same thickness as that of a quasi-focal length 40 of the convex lens 11, and is formed in a sheet form.

A printed quasi-focal length-printing layer 43 through which a real picture and a stereoscopic picture or special effects can be seen is formed beneath the transparent sheet 20.

A graphic printing surface 41 and a stereoscopic printing surface 42 are printed in the quasi-focal length-printing layer 43. It looks like that the graphic printing surface 41 is placed on the stereoscopic printing surface 42. Thus, the graphic printing surface 41 can display a subject figure, a photograph of a product, various colors and so on.

In this case, the stereoscopic printing surface 42 or a special effect printing surface 42-1 of the quasi-focal length-printing layer 43 comprises a graphic pattern that is largely continuous up, down, left and right, as shown in FIGS. 9 and 10, and thus displays stereoscopic displays, special effects and the like.

As a result, it enables the stereoscopic printing surfaces 42, 42-1 and the graphic printing surface 41 of the quasi-focal length-printing layer 43 to be felt as a visual difference or to be differently seen in a different of a feeling of depth or special effects (stereography, a motion, color conversion, etc.).

However, in the stereoscopic printing of the conventional IP method as described above, several problems must be solved. In other words, the general printing method employing the stereoscopic printing surface 42 and the graphic printing surface 41 is represented by colors overlapped with (C, M, Y, K) pattern angle of the offset screen halftones. A certain angle and a pattern arrangement structure of the convex lenses 11 to form the surface of the stereoscopic plastic sheet are overlapped with a certain pattern arrangement structure of the offset screen halftone (C, M, Y, K), resulting in a moire phenomenon.

The general offset printing method formed by the screen halftones (C, M, Y, K) is referred to as an “AM (Amplitude Modulation) screen-printing method”.

However, this phenomenon does not become problematic in not printed, but photographed photograph contents or printed matter by the inkjet printing method with high resolutions. Photographed photograph development products are largely formed by light with R, G and B colors. Since they do not have halftones like offset screen printing, printed matter of most high-resolution inkjet printing methods are not maintained as a piece of corpuscle due to a spread phenomenon when corpuscles of ink (the ink of C, M, Y, K or 6 color) to form a printing surface are printed on paper, but results in color mixing. Thus, natural gradation tones are formed between the corpuscles.

Therefore, in the present invention, based on this fact, a FM (Frequency Modulation) screen-printing method (that is, a printing method similar to the inkjet printing method) can be applied in order to remove the moire phenomenon in the stereoscopic printing.

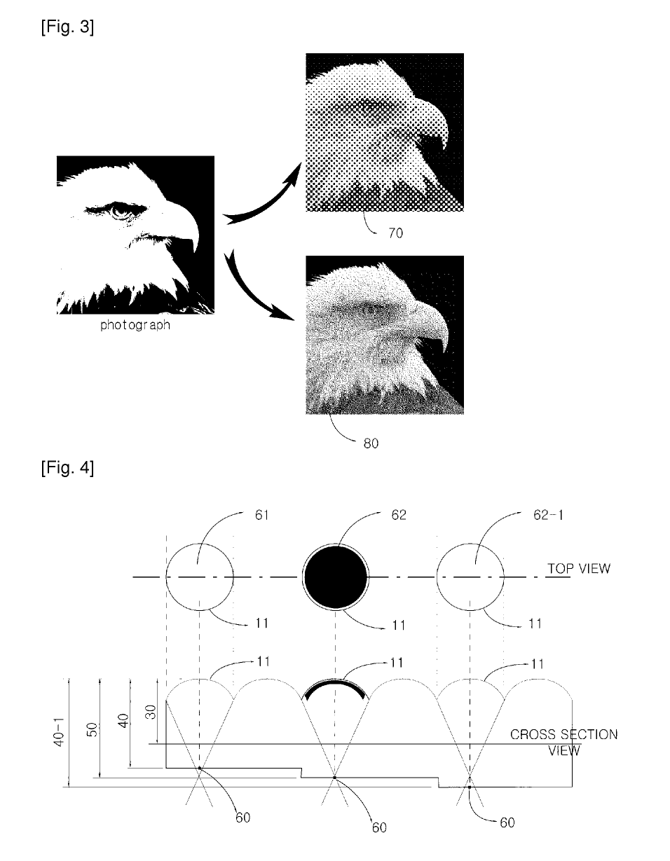

This is described with reference to FIG. 3.

It can be said that if the AM screen-printing method is an analog printing method, the FM screen-printing method is a digital printing method. A significant difference between the AM screen-printing method and the FM screen-printing method lies in a method of representing shadows of a figure. The AM screen-printing method is a method of controlling shadows through a combination of the colors (C, M, Y, K) as a general printing method by size conversion of the screen halftone arrangement structure 70 and halftones. The FM screen-printing method 80 is a method of representing shadows of a figure by the degree of density of a plurality of unspecified microdots 60, not the offset screen halftone (C, M, Y, K) structure of a specific pattern with the development of printing technology called recent CTP (Computer To Plate) output.

However, even though the FM screen-printing method 80 is a printing method similar to the inkjet printing method, another problem occurs in printing of the stereoscopic plastic sheet 1 of the present invention.

In other words, in the stereoscopic printing, a method of directly printing printed matter on the transparent plastic convex lens sheet rather than a method of printing the printed matter and then adhering it to the transparent plastic convex lens sheet is a preferred method in order to reduce the process. Thus, another problem, called a glitter phenomenon, occurs since the ink spread phenomenon is not generated as in the case of printing using the latter method.

Therefore, in this method, only the moire phenomenon can be removed simply, but the unspecified microdot 60 forming colors repeatedly appear and disappear like a glittering phenomenon along a viewer's sight movement. Consequently, another problem, called the glitter phenomenon in which resolutions seen by the naked eyes look very rough, arises.

For example, this becomes more problematic when representing the human skin color, etc. In other words, the human skin color in offset printing largely comprises a combination of yellow (Y) color and red (M) color halftones as a pink-series gradation tone. This is because the red (M) color to having an effect on shadows of the human skin color causes to make the human skin color look rough a pitted face. In other words, even in the case of the FM screen-printing method comprising the microdot 60, there is a density distance of the microdots 60 of about 30% to 70%, which form the shadow. This is because, as shown in FIG. 6, the microdot 60 is enlarged on a piece of the convex lens 62 along the movement of a viewer's sight due to a focal expansion phenomenon 62 of the convex lenses 11 to form the stereoscopic plastic sheet 2 by the positive focal length-printing layer, and thus results in a phenomenon in which the microdot looks glittering. When the printed matter is directly seen by the naked eyes, it looks clear and clean. This is a phenomenon that is generated when the printed matter is seen through the convex lens layer 10.

Further, to solve this problem, if it is sought to employ FM screen halftones of ultra-corpuscles, still another problem arises. This is because ink transfer by ultra-corpuscles exceeds its limit in view of a structural characteristic of the existing ink transfer type printing machine. In other words, this is because ink painted on a PS plate formed of ultra-corpuscles is not correctly transferred to printed matter, and color is not represented accurately.

Dot resolution of the FM screen type by the existing machine apparatus is mostly fabricated to represent 2400 dpi to 4000 dpi. This phenomenon largely occurs as resolutions are increased.

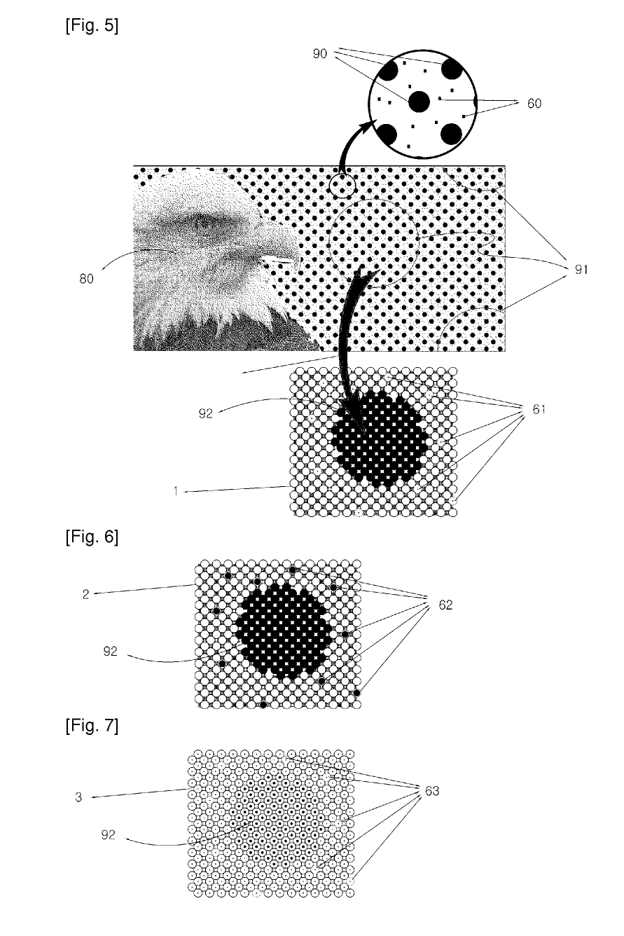

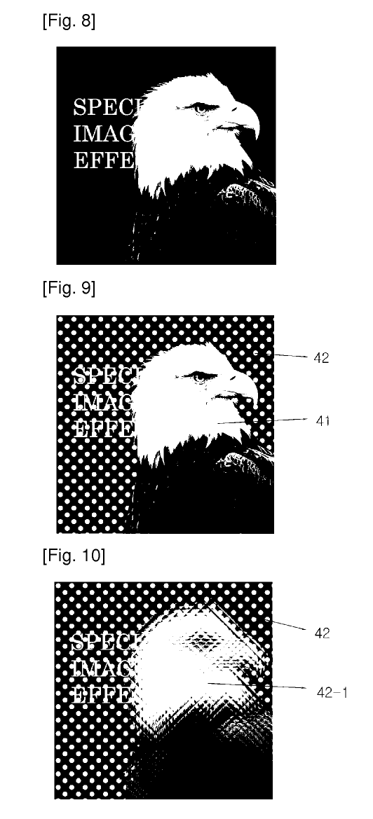

Therefore, the present invention can solve the problems caused by the moire phenomenon and the glitter phenomenon as shown in FIGS. 4 and 5.

The degree that the glitter phenomenon cannot be seen by the human's naked eyes well increases as the pitch of the convex lenses to constitute the stereoscopic plastic sheet 1 has the lens size and distance of high resolutions and the size of the convex lens 11 decreases. However, printing becomes more difficult that much.

Further, in general, in a lens arrangement structure of 1001 pi or less, as the size of the convex lens 11 increases, the glitter phenomenon seen by the naked eyes will become more profound. This is because there occurs a phenomenon in which the C, M, Y, K microdots 60 of the FM screen-printing method are enlarged as large as the size of the convex lens, appear and then disappear in an unspecified manner according to a viewer's sight between the respective convex lenses.

Thus, in the present invention, as a solution to minimize this phenomenon, the printing layer 43 is formed in the quasi-focal lengths 40, 40-1 where the location of the printing layer corresponding to the convex lens layer 10 is deviated a little from an accurate positive focal length 50 of the convex lenses 11, so that the microdots 60 seen through the convex lenses 11 generate blue and phenomena. It is therefore possible to remove the glitter phenomenon in the stereoscopic FM screen-printing method.

However, in this case, it is required that the graphic pattern 90 of the stereoscopic printing surface 42 be represented and maintained as a clear stereoscopic picture by the convex lenses 11. Further, the stereoscopic printing surface 42 must be fabricated within a quasi-focal length range of the convex lenses 11 so that it can represent the stereoscopic effect through the convex lens layer 10.

For example, assuming that the microdot 60 having a lens pitch of 20 LPI and FM screen type printing resolutions of 2400 dpi is printed, the meaning that the focal length of the lens is correct numerically refers to that there is an expansion phenomenon as large as the ratio 1:120. Therefore, the microdot 60 enlarged by 120 times looks filled up in one convex lens 11, and appears as the glitter phenomenon in which the microdot appears and then disappears as the size of the enlarged dot 62 as large as the lens size according to a moving sight.

Therefore, a range of representing an accurate focal length of one convex lens exists within representation focal length tolerance of 1/120 of the diameter size of the convex lens 11.

Thus, instead of forming the printing layer in the representation focal length as much as 1/120 of the size of the convex lens 11, if the printing layer is formed in the quasi-focal length 40 whose focus is controlled to become blur as much as 2/120 of the size of the convex lens 11, the shape of the microdot 61, which is formed in the quasi-focal length 40 and seen through a piece of the convex lens 11, generates a blur phenomenon as much as 2/120 compared with 1/120 (that is, about 50%) than the shape of the microdot 62, which is formed in the positive focal length 50 and seen through a piece of the convex lens 11. Accordingly, the glitter phenomenon can disappear.

In contrast, the definition of the stereoscopic printing surface 42 that should be represented as a clear stereoscopic picture is accomplished by an image-combined picture 92 in which a graphic pattern 90 relatively larger than the microdot 60 is gathered stereoscopically through the convex lenses 11 and projected. Thus, the definition of an intended stereoscopic graphic shape varies depending on whether the lenses located on the side of the gathered convex lenses make the colors of the stereoscopic graphic pattern 90 look filled up or not as large as the number of one convex lens 11 according to the movement of a viewer's sight.

Accordingly, error projected corresponding to the size of one convex lens 11 is very small to the extent that the degree of stereoscopic definition depending on the movement of a viewer's sight as much as 2/120 ( 1/60=1.6%) is reduced. Consequently, the degree of definition depends on a difference in the degree that how accurately has the graphic pattern 90 of the printed stereoscopic printing surface 42 been printed in the quasi-focal length 40 rather than the blur phenomenon by the quasi-focal length 40.

In reality, color error or error in the degree of definition depending on ink transfer, which is generated in the printing process, 3% or more in the case of 2400 dpi and 5% or more in the case of 4000 dpi. Therefore, there is almost no difference compared with the degree of accurate stereoscopic definition of the stereoscopic plastic sheet 2 printed in the printing layer of the positive focal length 50. It is therefore possible to fabricate the clear stereoscopic plastic sheet 1 of the FM screen-printing method from which the glitter phenomenon has been removed. A proportional optical boundary depending on printing resolutions and the size of the convex lens 11 exists in the quasi-focal length 40. In other words, the quasi-focal length 40 has an accurate focal length and is formed within tolerance accordingly. Thus, if the printing layer is formed in the non-focal length 30 as shown in FIG. 7, care must be taken of because the stereoscopic effect by the convex lenses 11 and the degree of definition are also removed.

Further, the stereoscopic plastic sheet 1 by the above-mentioned quasi-focal length-printing layer 43 can also be fabricated even in stereoscopic printing of the AM screen method.

Thus, a method of removing the moire phenomenon in the AM screen method by minimizing it is as follows.

Assuming that general offset print is normally performed with 175 lines (LPI), the stereoscopic plastic sheet 1 according to the present invention is excellent in reducing the moire phenomenon as resolutions (LPI) increase such as 200 lines, 300 lines, and 400 lines.

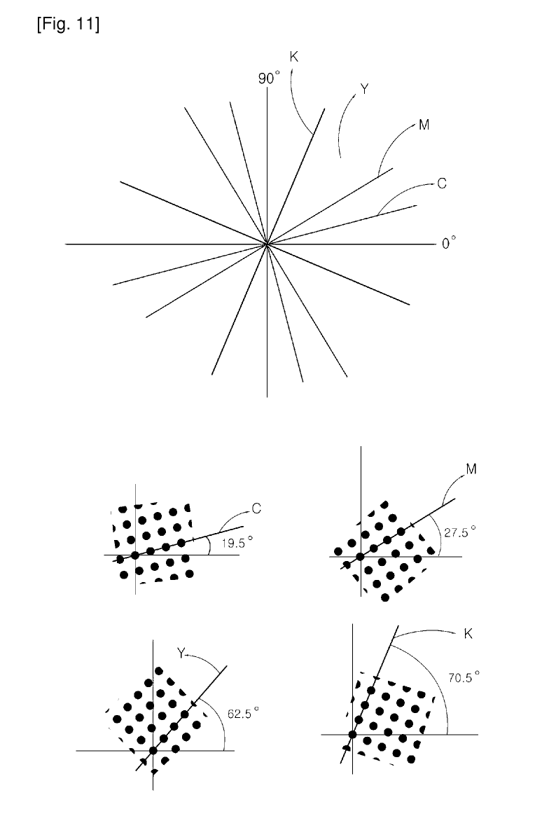

Further, as shown in FIG. 11, in order to minimize the moire phenomenon according to resolutions, it is necessary to control the angle of the offset screen halftone. It is also necessary for the size of the screen halftone to look minimal according to a controlled angle.

Therefore, in accordance with the experiment results according to an embodiment of the present invention, the angles differ as indicated in Table 1. As can be seen from the table, angles arranged according to respective resolutions indicate adequate angles capable of minimizing the moire phenomenon. In printing, one of the 4 colors (C, M, Y, K halftones) is selected within the same resolutions, but different angles are selected so that slopes can be set, respectively.

TABLE 1

| | Printing halftone density | | | | |
|---|---|---|---|---|---|
| | 175 LPI | 200 LPI | 300 LPI | 400 LPI | Remarks |
| Convex lens | 5.6° | 5.6° | 2.8° | 19.5° | Offset halftone |
| construction; | 8.4° | 11.3° | 18.2° | 27.5° | angle capable |
| Density 80 | 28° | 28.5° | 25.3° | 62.5° | of minimizing |
| LPIangle 45° | 34° | 39.5° | 33.7° | 70.5° | moire |
| | 56° | 42° | 40° | | phenomenon |
| | 62° | 48° | 50° | | |
| | 81.6° | 50.5° | 56.3° | | |
| | 84.4° | 61.5° | 64.7° | | |
| | | 78.7° | 71.8° | | |
| | | 84.4° | 87.2° | | |

Further, by controlling the 4-color (C, M, Y, K) halftone angles, the moire phenomenon can be minimized, but even the glitter phenomenon is not removed.

Therefore, even in the AM screen method, the graphic printing surface 41 and the stereoscopic printing surface 42 must be formed in the quasi-focal length-printing layer 43 so as to remove the glitter phenomenon.

First, in order to remove the glitter phenomenon, the fact that there is an important relationship between the size (lpi) of the convex lens 11 and resolutions (dpi) of printing should be utilized. This has been described above in the same manner as the FM screening method. Therefore, this is described in comparison with the stereoscopic printing method of the FM screen method.

The FM screen method represents resolutions as a ‘dpi’ unit, and the AM screen method uses a ‘LPI’ unit. Accordingly, 2400 dpi of the FM screen method can represent resolutions similar to 170 LPI of the AM screen method. The value can be controlled depending on an input value of data. In general, resolutions are represent by using 1200 dpi as 133 LPI, 1800 dpi as 150 LPI, 2540 dpi as 175 LPI and so on. In order to remove the glitter phenomenon, higher resolutions are advantageous.

Thus, a case where printing is performed as the quality of high resolutions is described as an example. In offset printing of the 4-color (C, M, Y, K) AM screening method comprising ultra-high resolution screen halftones of 500 LPI in the convex lens sheet having the size and arrangement of the convex lens 11 of 20 LPI, the distance between the halftones of printing and the size of the maximum diameter are 0.05 mm.

Further, in the event that printing is performed on the convex lens sheet having 20 LPI, when the pitch of the convex lens 11 is 20 LPI, the maximum diameter of one lens is 1.27 mm, so that the representation range of an accurate focal length exists in an enlarged focal forming distance of 25 times or more. Therefore, when the halftones have the blur phenomenon of about 50% and the moire phenomenon and the glitter phenomenon disappear accordingly, the degree of stereoscopic definition is about 8%, so that the degree of definition can be lowered. Thus, although the effect is smaller a little than that of the FM screen-printing method, the optimal stereoscopic plastic sheet 1 can also be fabricated in the AM screen-printing method.

Although the specific embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

According to the present invention as described above, in the event that a stereoscopic sheet 1 is monitored through a convex lens layer 10, a clear stereoscopic picture in which figures of a graphic printing surface 41 comprised of products or subject figures stay in the air or are entered into a stereoscopic printing surface 42 comprised of numerous figures or drawing produced by special printing. Accordingly, there are advantages in that a stereoscopic sheet through which a feeling of a high-level stereography can be felt can be provided, and a clear stereoscopic picture can be seen although it is monitored from any direction regardless of a position or direction where the stereoscopic plastic sheet 1 is placed because the lens consists of hemispherical convex lens 11.

Further, there are advantages in that the conventional IP printing method can be improved and modified to a printing method by computer graphics, the advantages of special effects of IP and printing suitable for mass production can be employed, a moire phenomenon and a glitter phenomenon, which may occur in the printing method, can be minimized, clear stereoscopic or special images can be seen, and a fabrication process can be reduced, increasing competitiveness.

1. An integral photography stereoscopic plastic sheet, comprising:
a convex lens layer 10 formed of transparent synthetic resin and having hemispherical convex lenses 11 formed on a top surface thereof in a row and column arrangement;
a transparent sheet 20 formed beneath the convex lens layer 10 and formed of a synthetic resin plate having a thickness corresponding to a quasi-focal length of the convex lens 11;
a graphic printing surface 41 printed on a bottom surface of the transparent sheet 20 to form a microdot structure 80 by a FM screen method and configured to enable a real picture to be seen through the graphic printing surface; and
stereoscopic printing surfaces 42, 42-1 printed in the same quasi-focal length as that of the graphic printing surface 41 and configured to enable graphics, which have been calculated and image-processed by computer graphics, to be seen through a stereoscopic screen,
wherein the convex lens layer 10 and the printing surfaces 41, 42, and 42-1 form visual arrangements corresponding to the transparent sheet 20 of a quasi-focal length distance, and is formed of one sheet.

2. The integral photography stereoscopic plastic sheet of claim 1, wherein the stereoscopic printing surfaces 42, 42-1 configured to enable the graphics, which have been calculated and image-processed by the computer graphics, to be seen through the stereoscopic screen are printed as a spot color figure or the microdot structure 80 by the FM screen method.

3. The integral photography stereoscopic plastic sheet of claim 1, wherein instead of the graphic printing surface 41 printed on the bottom surface of the transparent sheet 20 to form the microdot structure 80 by the FM screen method and configured to enable the real picture to be seen through the graphic printing surface, the graphic printing surface 41 formed as a halftone structure 70 by an AM screen-printing method of ultra-high resolutions is printed on the bottom surface of the transparent sheet 20 of the quasi-focal length.

4. The integral photography stereoscopic plastic sheet of claim 2, wherein a screen halftone angle is controlled so that a halftone arrangement of an AM screen-printing method can minimize a moire phenomenon or a glitter phenomenon.
